(19) United States
(12) Patent Application Publication
(10) Pub. No.: US 2007/0253581 A1
(43) Pub. Date: Nov. 1, 2007

(54) Toy in the form of a stuffed toy or 3-D character toy having a headset carrying strap with two headphone speakers and an audio player built into one of the speakers

(75) Inventor: Joseph A. Sutton, New York, NY (US)

Correspondence Address: Ezra Sutton, P.A., Plaza 9 Building, 900 Route 9 North, Woodbridge, NJ, 07095, US

(73) Assignees: Jay Franco & Sons, Inc.; Jay-At-Play Division

(21) Appl. No.: 11/511,095

(22) Filed: Aug. 28, 2006

Related U.S. Application Data
(63) Continuation-in-part of application No. 11/409,902, filed on Apr. 24, 2006, now Pat. No. 7,227,965.

(51) Int. Cl. G09F 27/00; A63H 5/00

(52) U.S. Cl. 381/124; 446/297; 446/270

(57) ABSTRACT

A toy in the form of a stuffed toy or 3-dimensional character toy having two headphone speakers on the ears of the toy. The toy has a head with ears, eyes, a body, arms and legs. The head of the toy includes a pair of headphones disposed on the head of the toy; wherein the headphones include outwardly facing speakers; and wherein one of the speakers has a built-in audio player. Each of the speakers are electrically connected to the audio player for allowing a user to listen to sound from the audio player through the headphone speakers. The head of the toy includes a headset carrying strap connected to the headphone speakers to give the appearance of a headset; the headset carrying strap also functions as a carrying strap for the toy. The body of the toy is usable as a pillow for receiving a user's head thereon to listen to sound or music from the audio player.

### RELATED APPLICATION

This is a Continuation-In-Part Application of the parent patent application Ser. No. 11/409,902 filed on Apr. 24, 2006.

### FIELD OF THE INVENTION

The present invention relates to a toy in the form of a stuffed toy or 3-dimensional character toy having a headset carrying strap with two headphone speakers mounted on the head. The toy is connected to an audio player within one of the headphone speakers for producing audio sound or music for use as an entertainment device for children and young adults. More particularly, the two speakers face outwardly so the user can share music with the stuffed toy.

### BACKGROUND OF THE INVENTION

Stuffed toys, animals, dolls and 3-dimensional characters, as well as backrests and toys, being used as entertainment devices are well-known in the prior art. These devices for the most part do not readily induce relaxation for the onset of sleeping by the user, even when using the above devices.

There remains a need for a toy in the form of a stuffed toy or 3-dimensional character toy with two headphones having outwardly facing speakers connected to the head of the stuffed toy for producing audio sounds or music from an audio player that is connected to at least one of the headphone speakers. Also, the stuffed toy would include a headset carrying strap for lifting and carrying the stuffed toy from place to place. Additionally, the toy with speakers would not need an amplifier to play sound or music coming from the audio player.

### DESCRIPTION OF THE PRIOR ART

Toys, headrests, cushions, backrests and stuffed toys having various accessories, designs, configurations, structures and materials of construction have been generally disclosed in the prior art. For example, U.S. Pat. No. 6,044,161 to LEE discloses a toy speaker for use as a combination headrest and sound delivery system for transmitting sounds, including music to a person's head. The toy speaker comprises a toy headrest having an upper surface for receiving and supporting a person's head. A lower body portion is adapted for support from an exterior stable surface. The toy speaker is constructed from a homogeneous flexible material. A pair of spaced apart loud speakers are mounted through the upper surface, within the lower body portion. This prior art patent does not disclose or teach the concept and structure of a toy in the form of a stuffed toy having an audio player within one of the two headphone speakers for producing music or sound, and having a headset carrying strap for carrying the stuffed toy.

U.S. Pat. No. 5,313,678 to REDEWILL discloses an acoustical toy adapted to support the head of a user including a core having an axis extending through a central section and opposing end sections. The end sections are bent from the central section and are generally coextensive in a common direction to provide the core with a U-shaped configuration. A spring is included for biasing the end sections toward each other to provide a snug fit relationship with the ears of the user and thereby attenuate environmental sound. The toy can be provided with speakers which can be connected through a conductor to an audio source such as a cassette or CD player. This prior art patent does not disclose or teach the concept and structure of a toy in the form of a stuffed toy having an audio player within one of the two headphone speakers for producing music or sound, and having a headset carrying strap for carrying the stuffed toy.

U.S. Pat. No. 4,440,443 to NORDSKOG discloses an improved resilient flexible headrest that is inflated with air or fluid, or is filled with foamed plastic material, preferably of various resiliencies. The headrest can be formed of plastic, cloth or the like, and has a cavity within which the upper end of the backrest of a chair, couch or the like is receivable. The body of the headrest has forwardly extending privacy wings which may be hinged and which include sound system speakers or the like. In one embodiment, the headrest may be U-shaped in plan view and include one or more straps and cinch means to releasably hold the headrest in place around the top of a backrest. The headrest can incorporate one or more sound system external loud speakers. This prior art patent does not disclose or teach the concept and structure of a toy in the form of a stuffed toy having an audio player within one of the two headphone speakers for producing music or sound, and having a headset carrying strap for carrying the stuffed toy.

U.S. Pat. No. 6,814,709 to SCHWARTZ et al. discloses a cushion/backrest including an integrated reading lamp tethered at the end of a flexible member for providing the user with a source of light for reading or watching television. The cushion may also include built-in massage motors for providing the user with a massaging action to the back. Controls for adjusting the massaging action and the reading lamp may be incorporated in an armrest. The bed rest cushion may also comprise a speaker or a plurality of speakers located in the headrest or armrests. The speakers may be capable of generating sound waves such as music from an audio source located within the bed cushion or from an external audio source. This prior art patent does not disclose or teach the concept and structure of a toy in the form of a stuffed toy having an audio player within one of the two headphone speakers for producing music or sound, and having a headset carrying strap for carrying the stuffed toy.

U.S. Pat. No. 5,074,821 to McKEEFERY et al. discloses a dual track recording device, such as a tape recorder. On a second track of the recorder an animation signal is recorded characterized by the signal having a frequency at any given time indicative of the then currently desired animation condition. A character-type toy is provided having a tape playback unit therein for playing back such pre-recorded dual track tapes. The character-type toy has an amplifier and speaker for reproducing the audio information, and a servo motor having a drive system for moving the character mouth elements and eyes with the desired animation. This prior art patent does not disclose or teach the concept and structure of a toy in the form of a stuffed toy having an audio player within one of the two headphone speakers for producing music or sound, and having a headset carrying strap for carrying the stuffed toy.

U.S. Design Pat. No. D311,472 to GILES discloses an ornamental design of a combined toy, cassette player and speakers. This ornamental design has a “butterfly” shaped toy with integral speakers that can be connected to the cassette player or other peripheral audio devices. This prior art patent does not disclose or teach the concept and structure of a toy in the form of a stuffed toy having an audio player within one of the two headphone speakers for producing music or sound, and having a headset carrying strap for carrying the stuffed toy.

None of the aforementioned prior art patents teach or disclose a toy in the form of a stuffed toy having outwardly facing headphone speakers having an audio player within one of the speakers for listening to music or sound by children and young adults, wherein the speakers are mounted on the head or ears of the stuffed toy. Also, none of the prior art references include a headset carrying strap for lifting and carrying the stuffed toy place to place.

Accordingly, it is an object of the present invention to provide a toy in the form of a stuffed toy or a 3-dimensional character toy having an audio player within one of the headphone speakers wherein the audio player is selected from the group consisting of a CD player, an Ipod, an MP3 player, a mini portable radio, a mini tape cassette player, a mini disc player and an AM/FM radio.

Another object of the present invention is to provide a toy in the form of a stuffed toy that includes outwardly facing headphone speakers on the head of the stuffed toy for allowing the user of the stuffed toy to listen to music or sound.

Another object of the present invention is to provide a toy in the form of a stuffed toy which is selected from a group consisting of stuffed toy animals or dolls such as a lion, a tiger, a bear, a horse, a pony, a bird, a monkey, a gorilla, a pig, a sheep, a lamb, a cow, a calf, a dog, a puppy, a cat, a kitten, a dinosaur, a rabbit, a bunny, a Raggedy-Anne or Andy doll, and the like.

Another object of the present invention is to provide a toy in the form of a stuffed toy that includes a headset carrying strap for lifting and carrying the stuffed toy from place to place.

Another object of the present invention is to provide a toy having headphone speakers that are easy to use and are durable and easily cleanable for repeated use by the user.

A further object of the present invention is to provide a toy having headphone speakers that can be mass-produced in an automated and economical manner and is readily affordable by the consumer.

### SUMMARY OF THE INVENTION

In accordance with the present invention, there is provided a toy in the form of a stuffed toy or 3-dimensional character toy having two headphone speakers on the ears of the toy. The toy has a head with ears and eyes, a body, arms and legs. The head of the toy includes a pair of headphones disposed on the head of the toy; wherein the headphones include outwardly facing speakers; and wherein one of the speakers has a built-in audio player. Each of the speakers are electrically connected to the audio player for allowing a user to listen to sound from the audio player through the headphone speakers. The head of the toy includes a headset carrying strap connected to the headphone speakers to give the appearance of a headset; the headset carrying strap also functions as a carrying strap for the toy. The body of the toy is usable as a pillow for receiving a user's head thereon to listen to sound or music from the audio player.

### BRIEF DESCRIPTION OF THE DRAWINGS

Further objects, features and advantages of the present invention will become apparent upon the consideration of the following detailed description of the present-preferred embodiment when taken in conjunction with the accompanying drawings, wherein:

FIG. 1 is a front perspective view of the toy with speakers of the preferred embodiment of the present invention showing an MP3 player being connected to one of the headphone speakers and a headset carrying strap;

FIG. 2 is a rear perspective view of the toy with speakers of the present invention showing an audio player connected to one of the headphone speakers;

FIG. 3 is a cross-sectional view of the toy with speakers of the present invention showing one of the speaker headphones being electrically attached to the audio player and the headset carrying strap;

FIG. 4 is an enlarged perspective view of the toy with speakers of the present invention showing multiple control buttons for controlling an AM/FM radio being electrically connected to one of the speaker headphones;

FIG. 5 is an enlarged exploded perspective view of the toy with speakers of the present invention showing the major component parts of the headphone speakers, the AM/FM radio, a battery pack and an electrical connection jack;

FIG. 6 is a perspective view of the toy with speakers of the present invention showing the headphone speaker components; and

FIG. 7 is a perspective view of the toy with speakers of the present invention showing a user listening to the audio player within one of the speakers and the headphone speakers being in operational use.

### DETAILED DESCRIPTION OF THE EMBODIMENTS PREFERRED EMBODIMENT 10

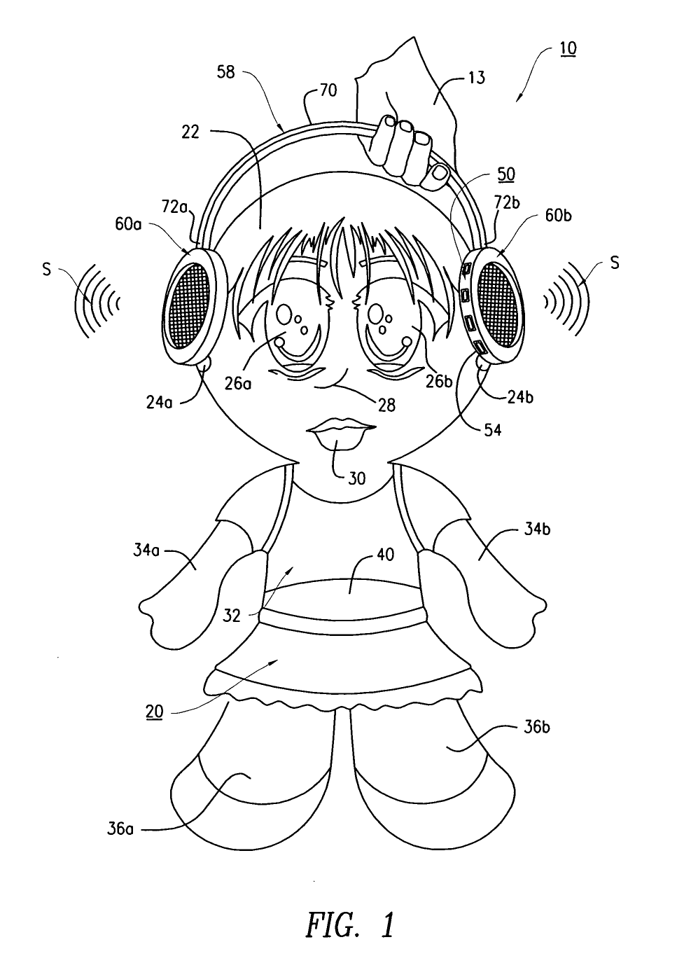

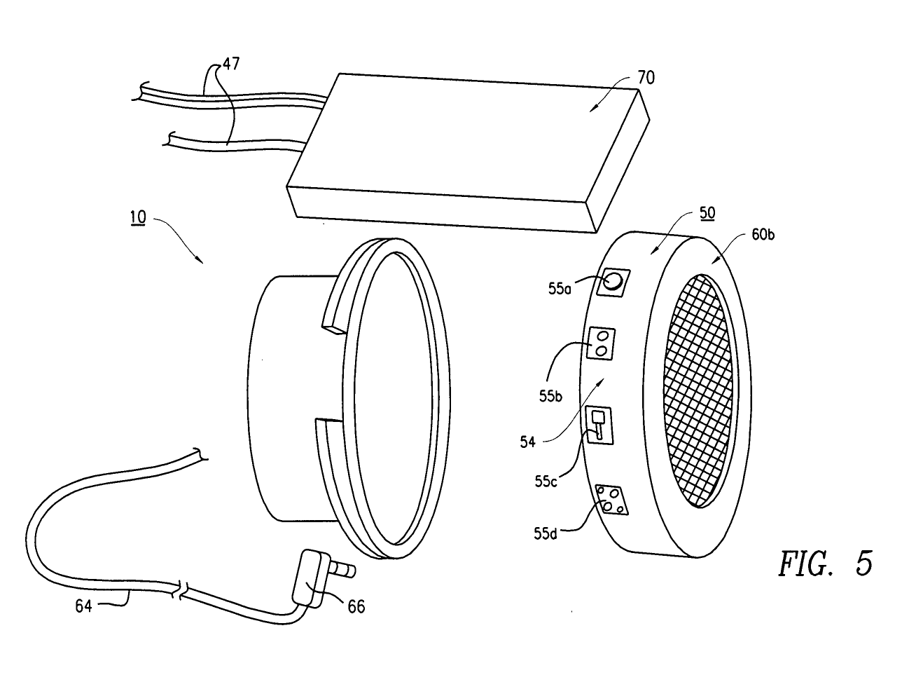

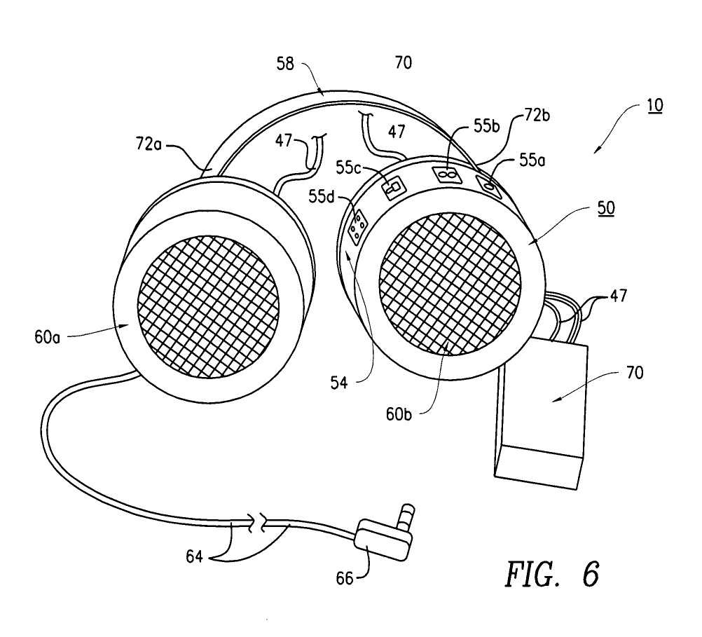

The toy 10 in the form of a stuffed toy having speakers 60a and 60b with a pocket compartment 42 for receiving an audio player 50 in one of the speakers 60a or 60b therein and its component parts of the present invention are represented in detail by FIGS. 1 through 7 of the drawings. The toy 10 is used for entertaining a child 14, a teenager or young adult with audio/sound (S) such as music, stories and the like being produced by the audio player 50. As shown in FIGS. 1 to 3, the toy 10 includes a toy housing 20 having a head 22 with ears 24a and 24b, eyes 26a and 26b, a nose 28, and a mouth 30. The toy housing 20 also includes a body 32 having a pair of arms 34a and 34b and a pair of legs 36a and 36b being attached thereto. The body 32 includes a back section 38 and a stomach section 40. It is understood that the toy 10 may be a stuffed toy or a 3-dimensional character toy selected from the group consisting of a lion, a tiger, a bear, a pony, or dinosaur, a horse, a pig, a bird, a monkey, a gorilla, a sheep, a lamb, a cow, a calf, a dog, a puppy, a cat, a kitten, and a doll.

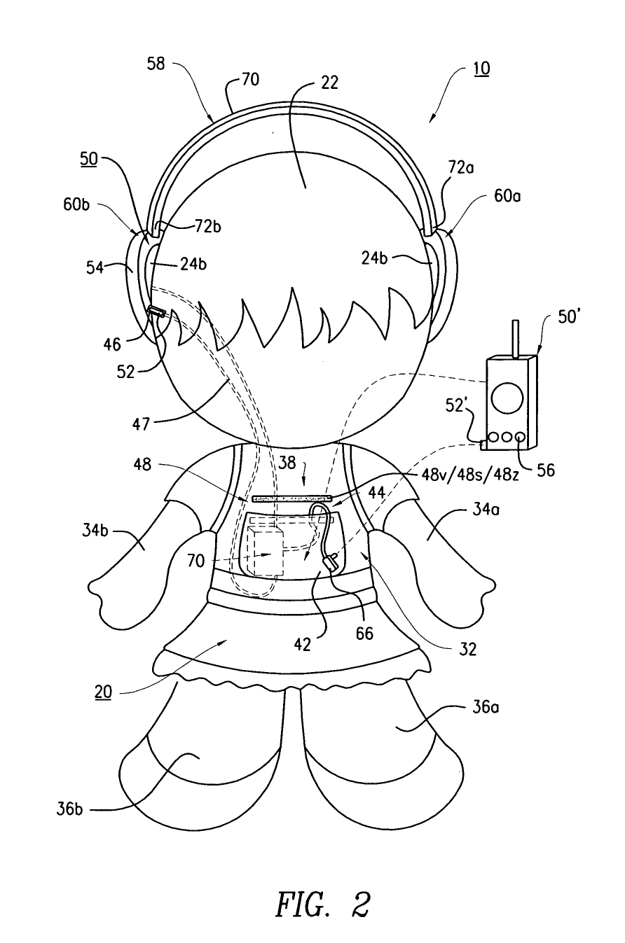

The back section 38 of body 32 includes an optional pocket compartment 42 having a pocket opening 44 for receiving an audio player 50 and/or a battery pack 70 therein. The toy 10 includes a plug receptacle 46 within one of the speakers 60a or 60b for receiving and electrically connecting via electrical wire 47 to an outlet plug 52 of the audio player 50, as shown in FIG. 2 of the drawings. The audio player 50 may be in the form of a CD player, an Ipod 56, an MP3 player, a mini radio, a mini cassette player and an AM/FM radio 54. The pocket opening 44 includes closing means 48 for retaining and holding the audio player 50 and/or the battery pack 70 within the pocket compartment 42. The closing means 48 for the pocket opening 44 includes hook and loop fasteners 48V, male and female snap fasteners 48S, a zipper 48Z, buttons, string ties and the like.

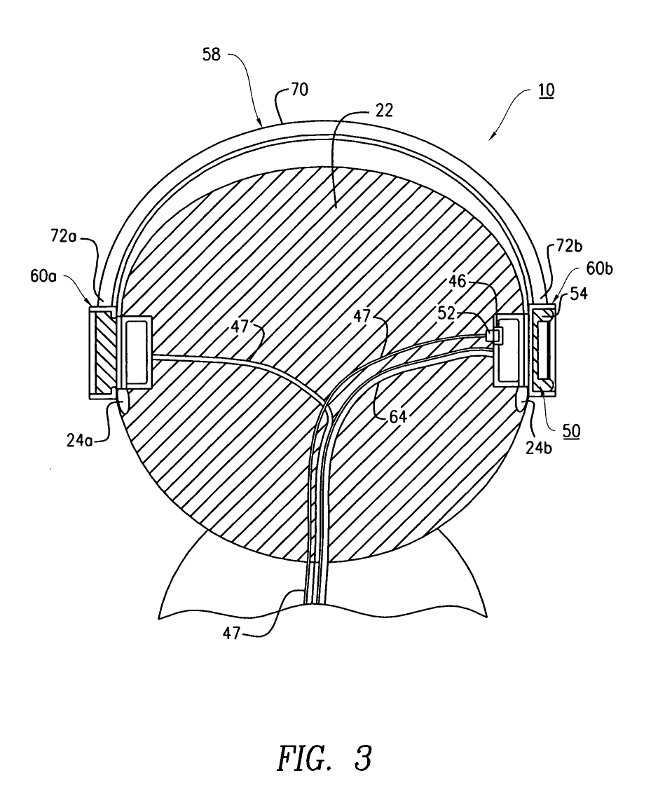

The head 22 of the plush toy 10 includes a headphone set 58 having a pair of headphone stereo speakers 60a and 60b that are positioned on each of the ears 24a and 24b, or head 22, as shown in FIGS. 1 and 3 of the drawings. One of the speakers 60a or 60b includes a built-in AM/FM radio 54 adjacent and contact with one of the headphone speaker 60a or 60b. The AM/FM radio 54 includes a plurality of control buttons 55a, 55b, 55c and 55d for controlling power, AM or FM band, station selection, and sound volume, respectively. Also, one of the speakers 60a or 60b includes an electrical connection jack 66 for electronically connecting to the outlet plug 52′ of another audio player 50′. In alternate designs, one of the speakers 60a or 60b can include the iPOD player 56 or the MP3 player, or the mini cassette player instead of the AM/FM radio 54 as part of one of the headphone speakers 60a or 60b, being a built-in unit. Further, each of the speakers 60a and 60b are electrically connected by a connection wire 64 to the plug receptacle 46, allowing a user to listen to the audio/sound(S) from another audio player 50′ through the speakers 60a and 60b, when the first audio player 50 on speaker 60a or 60b is turned off.

The head 22 of the plush toy 10 also includes a headset carrying strap 70 for headphone set 58. The headset carrying strap 70 is used for carrying and lifting the plush toy 10 from place to place by a hand 13 of the user 14, as depicted in FIG. 1 of the drawings. The headset carrying strap 70 includes a first end 72a and a second end 72b, wherein each of the first and second ends 72a and 72b are connected to each of the headphone stereo speakers 60a and 60b (being adjacent to each of the ears 24a and 24b of the head 22 of plush toy 10, as depicted in FIG. 2), respectively, of plush toy 10 by stitching, stapling, gluing, laser welding or adhesives, as depicted in FIGS. 1 to 4 and 6 of the drawings.

In this manner, the headset carrying strap 70 of the present invention performs a dual function: it is connected to the headphone speakers 60a and 60b and thereby gives the appearance of a headset mounted on the plush toy 10, and strap 70 also performs the function of a carrying strap for the head 22 of the plush toy 10. Also, the plush toy 10 performs the function of a pillow and also functions to carry a radio player 54 in one of the speakers 60a or 60b for producing sound or music for entertainment.

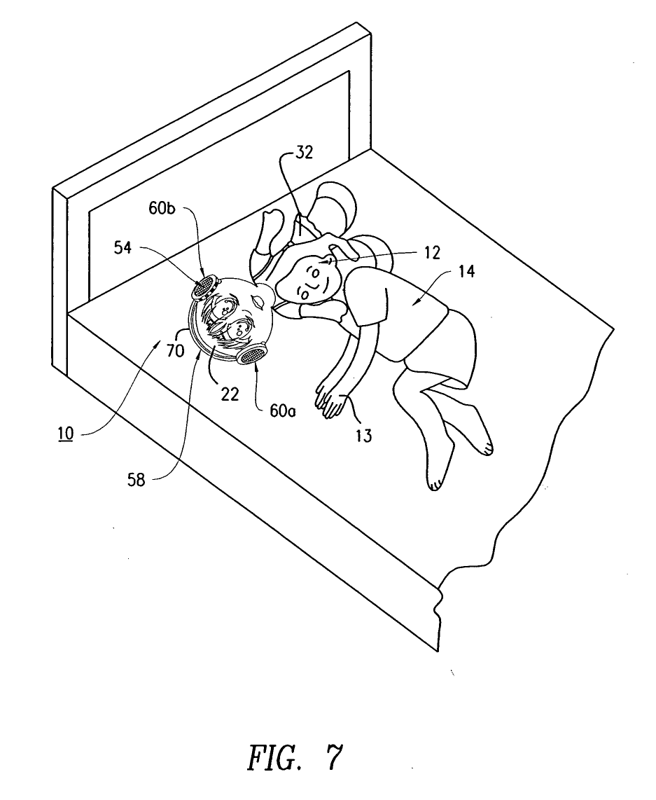

Additionally, as depicted in FIG. 7, the body 32 of the stuffed toy 10 is used as a toy for receiving the user's head 12 thereon.

### Operation of the Present Invention

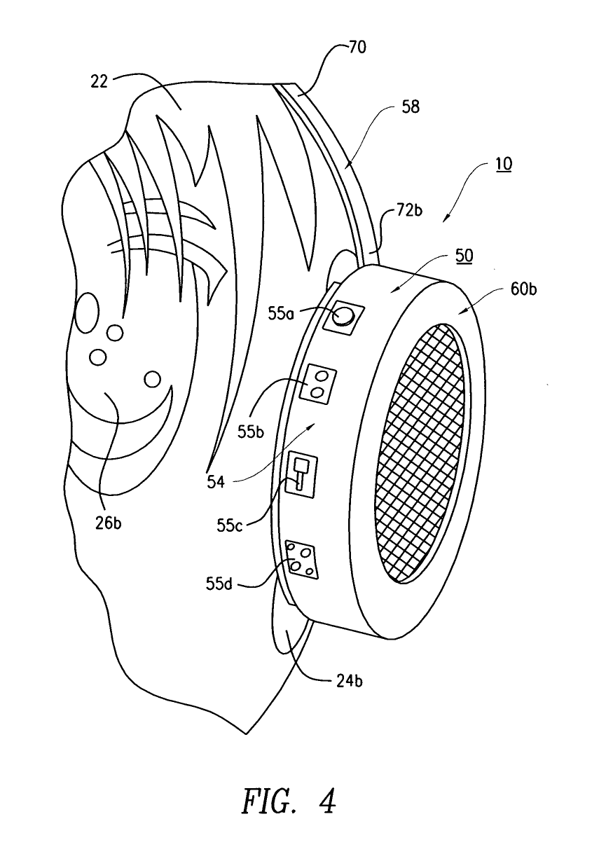

As shown in FIGS. 1 to 3 and 5, the toy 10 having the AM/FM radio 54 within headphone speaker 60b operates in the following manner: The user initially opens the closing means 48, such as the hook and loop fasteners 48V, on pocket opening 44. Next, the user would then insert the battery pack 70 into the pocket compartment 42 and electrically connect the battery pack 70 via electrical wires 47 on speakers 60a and 60b, as shown in FIGS. 3 to 6 of the drawings. The user then closes the hook and loop fasteners 48V on pocket opening 44, as shown in FIGS. 1 and 2 of the drawings. The next step has the user adjusting the control buttons 55a and 55b on speaker 60b in order to listen Alternatively, if the user is not listening to the AM/FM radio 54 and wants to listen to his/her iPOD 56. The user would also place iPOD 56 within pocket opening 44 of pocket compartment 42 next to the battery pack 70, accordingly, and then connect the outlet plug 52 to the iPOD 56. The user is now able to listen to the audio/sound coming from the outwardly facing speakers 60a and 60b of the iPOD player 52 while laying his/her head 12 on the stuffed toy 10 while relaxing, as shown in FIG. 7 of the patent drawings. The next step has the user adjusting the control buttons 55a to 55b on speaker 60a or 60b in order to listen to a particular station on the AM/FM radio, as depicted in FIG. 4. The user is now able to listen to the audio/sound(S) coming from the outwardly facing speakers 60a and 60b of the AM/FM radio 54 while laying his/her head 12 on the stuffed toy 10 while relaxing, as shown in FIG. 7 of the patent drawings.

Alternatively, if the user is not listening to the AM/FM radio 54 (the AM/FM radio 54 is turned off) and wants to listen to his/her iPOD 56, the user would also place the iPOD within pocket opening 44 of pocket compartment 42 next to the battery pack 70, and then the user connects the electrical connection jack 66 to the outlet plug 52′ of the iPOD 56. The user is now able to listen to the audio/sound(S) coming from the outwardly facing speakers 60a and 60b of the iPOD player 56 while laying his/her head 12 on the stuffed toy 10 while relaxing, as shown in FIG. 7 of the patent drawings.

### Advantages of the Present Invention

Accordingly, an advantage of the present invention is that it provides for a toy in the form of a stuffed toy or a 3-dimensional character toy having an audio player within one of the headphone speakers wherein the audio player is selected from the group consisting of a CD player, an iPOD, an MP3 player, a mini portable radio, or a mini tape cassette player, a mini disc player and an AM/FM radio.

Another advantage of the present invention is that it provides for a toy in the form of a stuffed toy that includes outwardly facing headphone speakers on the head of the stuffed toy for allowing the user of the toy to listen to music or sound.

Another advantage of the present invention is that it provides for a toy that includes a plug receptacle for connection to the audio player, and a connection wire electrically connected to the headphone speakers.

Another advantage of the present invention is that it provides for a toy in the form of a stuffed toy which is selected from a group consisting of stuffed toy animals or dolls such as a lion, a tiger, a bear, a horse, a pony, a bird, a monkey, a gorilla, a pig, a sheep, a lamb, a cow, a calf, a dog, a puppy, a cat, a kitten, a dinosaur, a rabbit, a bunny, a Raggedy-Anne or Andy doll, and the like.

Another advantage of the present invention is that it provides for a toy in the form of a stuffed toy that includes a headset carrying strap for lifting and carrying the stuffed toy from place to place.

Another advantage of the present invention is that provides for a toy having headphone speakers that is easy to use and is durable and easily cleanable for repeated use by the user.

A further advantage of the present invention is that it provides for a toy having headphone speakers that can be mass-produced in an automated and economical manner and is readily affordable by the consumer.

A latitude of modification, change and substitution is intended in the foregoing disclosure, and in some instances, some features of the invention will be employed without a corresponding use of other features. Accordingly, it is appropriate that the appended claims be construed broadly and in a manner consistent with the spirit and scope of the invention herein.

1. A toy in the form of a stuffed toy or 3-dimensional character toy having a headset thereon including two headphone speakers on the head of the toy, comprising:
a) a toy having a 3-dimensional a head with ears and eyes, a body, arms and legs; said headset including two headphone speakers connected by a headset carrying strap; said headset carrying strap extending over the head of said toy between said headphone speakers;
b) said head of said toy including said pair of headphone speakers disposed on said head of said toy; wherein said headphone speakers include outwardly facing speakers; and wherein one of said headphone speakers has a built-in audio player;
c) said headphone speakers being electrically connected to a plug receptacle and to said audio player for allowing a user to listen to sound from said audio player through said headphone speakers; said plug receptacle being connected to connecting wires which are connected to said headphone speakers;
d) said headset carrying strap connected to said headphone speakers to give the appearance of said headset, said headset carrying strap also functioning as a carrying strap for said toy; and
e) said body of said toy being usable as a pillow for receiving a user's head thereon to listen to sound or music from said audio player.

2. A toy having speakers in accordance with claim 1, wherein said audio player is selected from the group consisting of a CD player, an iPod, an MP3 player, a mini radio, a mini tape cassette player, a mini disk player, and an AM-FAM radio.

3. A toy having speakers in accordance with claim 1, wherein said toy is a stuffed toy doll.

4. A toy having speakers in accordance with claim 1, wherein said toy is selected from the group consisting of a lion, a tiger, a bear, a pony, a dinosaur, a horse, a pig, a bird, a monkey, a gorilla, a sheep, a cow, a dog, a cat, and a doll.

5. A toy having speakers in accordance with claim 1, wherein said headphone speakers are mounted on said ears of said toy; and said ears are movable with respect to the head of the toy.

6. A toy having speakers in accordance with claim 1, wherein said outwardly facing speakers include faces having holes therein.

7. A toy having speakers in accordance with claim 1, wherein each of said headphone speakers are positioned in an outwardly facing direction relative to the head of said toy for maximizing the sound of said audio player.

8. A toy having speakers in accordance with claim 1, wherein said headphone speakers are non-detachably connected to said head of said toy by stitching, stapling, glueing, laser welding, adhesives and the like.

9. A toy having speakers in accordance with claim 1, wherein one of said headphone speakers includes a connection jack for electrically connecting to other audio players when said built-in audio player is not in use.

10. A toy in the form of a stuffed toy or 3-dimensional character toy having a headset thereon including two headphone speakers on the head of the toy, comprising:
a) a toy having a 3-dimensional head with ears and eyes and a body; said headset including two headphone speakers connected by a headset carrying strap; said headset carrying strap extending over the head of said toy between said headphone speakers;
b) said head of said toy including a pair of headphones mounted on said head of said toy; wherein said headphone speakers include outwardly facing speakers facing away from said head and wherein one of said headphone speakers has a built-in audio player;
c) said headphone speakers being connected to a plug receptacle and to said audio player for allowing a user to listen to sound from said audio player through said headphone speakers; said plug receptacle being connected to connecting wires which are connected to said headphone speakers;
d) said headphone speaker including a connection jack for electrically connecting to other audio players when said built-in audio player is not in use;
e) said headset carrying strap connected to said headphone speakers to give the appearance of a headset, said headset carrying strap also functioning as a carrying strap for said toy; and
f) said body of said toy being usable as a pillow for receiving a user's head thereon to listen to sound or music from said audio player.

11. A toy having speakers in accordance with claim 10, wherein said audio player is selected from the group consisting of a CD player, an iPod, an MP3 player, a mini radio, a mini tape cassette player, a mini disc player, and a AM-FM radio.

12. A toy having speakers in accordance with claim 10, wherein said toy is a stuffed toy doll.

13. A toy having speakers in accordance with claim 10, wherein said toy is selected from the group consisting of a lion, a bear, a pony, a dinosaur, a horse, a pig, a bird, a monkey, a gorilla, a sheep, a cow, a dog, a cat, and a doll.

14. A pillow having speakers in accordance with claim 10, wherein said outwardly facing speakers include faces having holes therein.
